(19) United States
(12) Patent Application Publication
(10) Pub. No.: US 2026/0172831 A1
(43) Pub. Date: Jun. 18, 2026

(54) VEHICLE SERVICE PROVIDING METHOD, AND SERVER AND SYSTEM FOR THE SAME

(71) Applicants: Hyundai Motor Company, Seoul (KR); Kia Corporation, Seoul (KR)

(72) Inventor: Tae Kyu KIM, Hwaseong-si (KR)

(21) Appl. No.: 19/230,761

(22) Filed: Jun. 6, 2025

(30) Foreign Application Priority Data
Dec. 16, 2024 (KR) 10-2024-0187332

(51) Int. Cl. H04W 12/082; H04L 9/40; H04W 68/00

(52) U.S. Cl. CPC H04W 12/082; H04L 63/102; H04W 68/00

(57) ABSTRACT

There is proved vehicle service provision method including: sharing, by a server, a right to use a connected car service for a first vehicle with a recipient and linking a connected car service account; sharing, by the server, a right to use a connected car service for a second vehicle with a recipient and linking the connected car service account; notifying, by the server, a first vehicle owner terminal corresponding to a terminal of an owner of the first vehicle that the recipient is linked to the second vehicle after the connected car service account of the recipient is linked to the second vehicle; and stopping, by the server, sharing of the right to use the connected car service for the first vehicle with the connected car service account of the recipient based on a request of the first vehicle owner terminal.

### CROSS-REFERENCE TO RELATED APPLICATION(S

The present application is based on and claims the benefit of priority under 35 U.S.C. 119 to Korean Patent Application No. 10-2024-0187332, filed on December 16, 2024, in the Korean Intellectual Property Office, the disclosure of which is herein incorporated by reference in its entirety.

### 1. Technical Field

The present disclosure is related to a vehicle service provision technology and, more particularly to a vehicle service provision method for preventing damage caused by unintended vehicle sharing by notifying the owner of a vehicle that the vehicle is shared, and a server and a system for the same.

### 2. Background

Recently, a vehicle is being configured to provide various services, based on communication with a server connected through a communication network, and such vehicles are also called a connected car, a smart vehicle, or an intelligent vehicle.

The owner of a vehicle may share a right to use a service so that another person (hereinafter, a recipient) may use a connected car service for the vehicle thereof, and the recipient may link a connected car account thereof to the profile of the vehicle, thereby being provided with the connected car service through the vehicle, based on the shared right to use the service.

Even though the connected car account of the recipient is linked to the profile of another vehicle or the account of the recipient is disconnected from the vehicle of the owner (i.e., the recipient is highly likely to no longer use the connected car service for the vehicle of the owner) because the recipient uses the other vehicle, if sharing of the right to use the service for the vehicle is not stopped, the recipient has the right for the vehicle and may thus remotely control the vehicle of the owner.

There may be a case where the owner does not unintentionally cancel vehicle sharing with the recipient, for example, because the owner does not remember sharing the vehicle with the recipient.

Therefore, a method is required to enable the owner to know that the vehicle is shared so that the owner may withdraw the previously shared right to use the service at an appropriate time.

The foregoing described as the background art is intended merely to aid in the understanding of the background of the present disclosure, and is not intended to mean that the present disclosure falls within the purview of the related art already known to those skilled in the art.

### SUMMARY

A technical aspect of an embodiment of the present disclosure is to provide a vehicle service provision method for preventing damage caused by unintended vehicle sharing by notifying the owner of a vehicle that the vehicle is shared, and a server and a system for the same.

A technical aspect of an embodiment of the present disclosure is to provide a vehicle service provision method implemented to notify the owner of a vehicle that a recipient is sharing the vehicle to disconnect an account of the recipient and to stop vehicle sharing with the recipient when the recipient sharing the vehicle links the account through another vehicle, and a server and a system for the same.

The technical subjects pursued in the present disclosure may not be limited to the above-mentioned technical subjects, and other technical subjects which are not mentioned may be clearly understood from the following descriptions by those skilled in the art to which the present disclosure pertains.

To achieve the foregoing aspects, a server for providing a connected car service according to an embodiment of the present disclosure may notify a first vehicle owner terminal corresponding to a terminal of an owner of a first vehicle that a recipient is linked to a second vehicle, and may stop sharing of a right to use a connected car service for the first vehicle with a connected car service account of the recipient according to a request of the first vehicle owner terminal when the connected car service account of the recipient is linked to a profile of the second vehicle in a situation in which the connected car service account of the recipient with which the right to use the connected car service for the first vehicle is shared is previously linked to a first profile of the first vehicle.

According to an embodiment of the present disclosure, the second vehicle may be a vehicle of the recipient or a vehicle of a third person.

According to an embodiment of the present disclosure, when the second vehicle is the vehicle of the third person, the server may receive a request to share a right to use a connected car service for the second vehicle from the terminal of the third person.

According to an embodiment of the present disclosure, the server may notify the first vehicle owner terminal that the recipient is linked to the second vehicle, and may then stop vehicle sharing of the first vehicle with the recipient when receiving a request to stop sharing of the first vehicle with the recipient from the first vehicle owner terminal.

According to an embodiment of the present disclosure, the server may disconnect the account of the recipient from the first vehicle, and may transmit account disconnection completion with respect to the recipient to the first vehicle.

According to an embodiment of the present disclosure, the server may stop vehicle sharing of the first vehicle with the recipient, and may transmit a sharing stop notification message with respect to the first vehicle to the terminal of the recipient.

A vehicle service provision system according to an embodiment of the present disclosure may include: a first vehicle including a first vehicle terminal; a second vehicle including a second vehicle terminal; and a server linked to the first vehicle and the second vehicle and configured to provide a connected car service to the first vehicle terminal and the second vehicle terminal, wherein the server may notify a first vehicle owner terminal corresponding to a terminal of an owner of a first vehicle that a recipient is linked to a second vehicle, and may stop sharing of a right to use a connected car service for the first vehicle with a connected car service account of the recipient according to a request of the first vehicle owner terminal when the connected car service account of the recipient is linked to a profile of the second vehicle in a situation in which the connected car service account of the recipient with which the right to use the connected car service for the first vehicle is shared is previously linked to a first profile of the first vehicle.

According to an embodiment of the present disclosure, the server may perform vehicle sharing of the first vehicle with the recipient according to a request of the first vehicle owner terminal, and may link the account of the recipient according to a request of the first vehicle terminal.

According to an embodiment of the present disclosure, the server may perform vehicle sharing of the second vehicle with the recipient according to a request of a second vehicle owner terminal corresponding to a terminal of an owner of the second vehicle, and may link the account of the recipient according to a request of the second vehicle terminal.

According to an embodiment of the present disclosure, the server may notify the first vehicle owner terminal that the recipient is linked to the second vehicle, and may then stop vehicle sharing of the first vehicle with the recipient when receiving a request to stop sharing of the first vehicle with the recipient from the first vehicle owner terminal.

According to an embodiment of the present disclosure, the server may disconnect the account of the recipient from the first vehicle, and may transmit account disconnection completion with respect to the recipient to the first vehicle.

According to an embodiment of the present disclosure, the server may stop vehicle sharing of the first vehicle with the recipient, and may transmit a sharing stop notification message with respect to the first vehicle to the terminal of the recipient.

According to an embodiment of the present disclosure, the first vehicle owner terminal may output a notification message of stopping sharing of the first vehicle with the recipient after being notified that the recipient is linked to the second vehicle, and may request the server to stop sharing of the first vehicle with the recipient when a sharing stop button is selected in the notification message of stopping the sharing.

A vehicle service provision method according to an embodiment of the present disclosure may include: sharing, by a server, a right to use a connected car service for a first vehicle with a recipient and linking a connected car service account; sharing, by the server, a right to use a connected car service for a second vehicle with a recipient and linking the connected car service account; notifying, by the server, a first vehicle owner terminal corresponding to a terminal of an owner of the first vehicle that the recipient is linked to the second vehicle when the connected car service account of the recipient is linked to the second vehicle; and stopping, by the server, sharing of the right to use the connected car service for the first vehicle with the connected car service account of the recipient according to a request of the first vehicle owner terminal.

According to an embodiment of the present disclosure, after the notifying, the stopping may be performed by the server when receiving a request to stop sharing of the first vehicle with the recipient from the first vehicle owner terminal.

According to an embodiment of the present disclosure, the stopping may include disconnecting, by the server, the connected car service account of the recipient from the first vehicle, and transmitting account disconnection completion with respect to the recipient to the first vehicle.

According to an embodiment of the present disclosure, the stopping may include stopping vehicle sharing of the first vehicle with the recipient, and transmitting a sharing stop notification message with respect to the first vehicle to the terminal of the recipient.

According to an embodiment of the present disclosure, the vehicle service provision method may further include: outputting, by the first vehicle owner terminal, a notification message of stopping sharing of the first vehicle with the recipient after being notified that the recipient is linked to the second vehicle; and requesting, by the first vehicle owner terminal, the server to stop sharing of the first vehicle with the recipient when a sharing stop button is selected in the notification message of stopping the sharing.

In addition to the above-mentioned solutions to the technical subjects, detailed particulars according to various embodiments of the present disclosure are included in the following description and the accompanying drawings.

According to an embodiment of the present disclosure, there may be provided a vehicle service provision method implemented to notify the owner of a vehicle that a recipient is sharing the vehicle to disconnect an account of the recipient and to stop vehicle sharing with the recipient when the recipient sharing the vehicle links the account through another vehicle, and a server and a system for the same.

Accordingly, it is possible to block an inappropriate recipient from accessing the vehicle in advance and prevent the owner of the vehicle from suffering damage due to unintended vehicle sharing.

Advantageous effects obtainable from the present disclosure may not be limited to the above-mentioned effects, and other effects which are not mentioned may be clearly understood from the following descriptions by those skilled in the art to which the present disclosure pertains.

### BRIEF DESCRIPTION OF THE DRAWINGS

The accompanying drawings are intended to aid understanding of embodiments of the present disclosure, and provide embodiments along with a detailed description. However, the technical features of the embodiments are not limited to specific drawings, and features disclosed in the respective drawings may be combined to form a new embodiment.

FIG. 1 illustrates an example of a configuration of a vehicle service provision system according to an embodiment of the present disclosure;

FIG. 2 illustrates an example of a message M provided by a first vehicle owner terminal according to an embodiment of the present disclosure;

FIG. 3 illustrates a vehicle service provision method according to an embodiment of the present disclosure;

FIG. 4 specifically illustrates linkage of an account of a recipient (S310) of FIG. 3; and

FIG. 5 illustrates an example of the configuration of a server according to an embodiment of the present disclosure.

### DETAILED DESCRIPTION

In describing the embodiments set forth herein, a detailed description of known functions or configurations incorporated herein will be omitted when it is determined that the description may make the subject matter of the embodiments set forth herein unclear. In addition, it should be appreciated that the accompanying drawings are provided only for the sake of easy understanding of the embodiments set forth herein, and the technical idea of the present disclosure is not limited to the accompanying drawings and includes all modifications, equivalents, or alternatives falling within the spirit and scope of the present disclosure.

Terms including an ordinal number such as "a first" and "a second" may be used to describe various elements, but the elements are not limited to the terms. The above terms are used merely for the purpose of distinguishing one element from other elements.

A singular expression may include a plural expression unless they are definitely different in a context.

As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as "A, B, and C", "A, B, or C", "at least one of A, B, and C", "at least one of A, B, or C", etc. as used herein may mean each listed item or all possible combinations of the listed items. For example, "at least one of A or B" may refer to (1) at least one A; (2) at least one B; or (3) at least one A and at least one B.

The terms "module" and "unit" used for the elements in the following description are given or interchangeably used in consideration of only the ease of writing the specification, and do not have distinct meanings or roles by themselves.

In the case where an element is referred to as being "connected" or "coupled" to any other elements, it should be understood that not only the element may be directly connected or coupled to the other elements, but also another element may exist therebetween. Contrarily, in the case where an element is referred to as being "directly connected" or "directly coupled" to any other element, it should be understood that no other element exists therebetween.

Hereinafter, embodiments set forth herein will be described in detail with reference to the accompanying drawings, and the same or similar elements are given the same and similar reference numerals regardless of figure numbers, so duplicate descriptions thereof will be omitted.

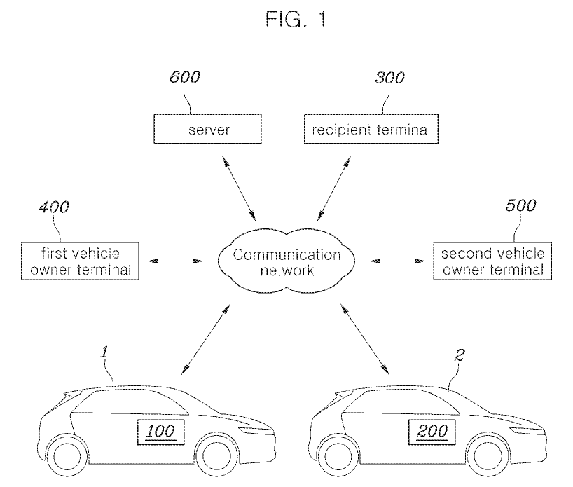

FIG. 1 illustrates the configuration of a vehicle service provision system according to an embodiment of the present disclosure.

Referring to FIG. 1, the vehicle service provision system may include a first vehicle terminal 100 mounted in a first vehicle 1, a second vehicle terminal 200 mounted in a second vehicle 2, a recipient terminal 300, a first vehicle owner terminal 400, a second vehicle owner terminal 500, and a server 600.

The first vehicle terminal 100, the second vehicle terminal 200, the recipient terminal 300, the first vehicle owner terminal 400, the second vehicle owner terminal 500, and the server 600 may be configured to communicate based on a preset communication network.

For example, the communication network may employ a wireless Internet technology, such as a wireless LAN (WLAN) (Wi-Fi), wireless broadband (Wibro), and/or World Interoperability for Microwave Access (WiMax), and/or a mobile communication technology, such as code-division multiple access (CDMA), global system for mobile communication (GSM), Long-Term Evolution (LTE), LTE-Advanced, and/or International Mobile Telecommunication (IMT)-2020, but is not limited to the mentioned communication technologies.

### First vehicle terminal 100

The first vehicle terminal 100 is mounted in the first vehicle 1, may implement an in-vehicle infotainment (IVI) system of the first vehicle 1, and may communicate with the server 600 to provide a connected car service.

For example, the first vehicle terminal 100 may manage user information in the form of a profile, and may provide a plurality of profile slots. Generally, the profile may include a plurality of user profiles and one guest profile. Each user profile except the guest profile may be linked to one connected car service account and one digital key.

A profile may be selected (logged in) through a user interface 130 of the first vehicle terminal 100 when the vehicle is key-on, or a user profile may be linked to each smart key (FOB) and automatically selected according to the smart key detected in the vehicle.

When a user profile is selected, the first vehicle terminal 100 may request the server 600 to link a connected car account, based on user information related to the selected profile.

According to an embodiment, when a user profile is selected by a recipient with whom the first vehicle 1 is shared, the first vehicle terminal 100 may request user authentication from the server 600 to link an account of the recipient.

After requesting the user authentication of the recipient from the server 600, the first vehicle terminal 100 may receive authentication success information from the server 600.

According to an embodiment, the first vehicle terminal 100 may receive a request to disconnect the connected account of the recipient from the server 600, and may disconnect the connected account of the recipient in response thereto.

### Second vehicle terminal 200

The second vehicle terminal 200 is mounted in the second vehicle 2, may implement an in-vehicle infotainment (IVI) system of the second vehicle 2, and may communicate with the server 600 to provide a connected car service.

For example, the second vehicle terminal 200 may manage user information in the form of a profile, and may provide a plurality of profile slots. Generally, the profile may include a plurality of user profiles and one guest profile. Each user profile except the guest profile may be linked to one connected car service account and one digital key.

A profile may be selected (logged in) through a user interface 130 of the vehicle terminal 200 when the vehicle is key-on, or a user profile may be linked to each smart key (FOB) and automatically selected according to the smart key detected in the vehicle.

When a user profile is selected, the second vehicle terminal 200 may request the server 600 to link a connected car account, based on user information related to the selected profile.

According to an embodiment, when a user profile is selected by a recipient with whom the second vehicle 2 is shared, the second vehicle terminal 200 may request user authentication from the server 600 to link an account of the recipient.

After requesting the user authentication of the recipient from the server 600, the second vehicle terminal 200 may receive authentication success information from the server 600.

### Recipient terminal 300

The recipient terminal 300 is a terminal of a recipient with whom the first vehicle 1 and the second vehicle 2 are shared, and may communicate with the server 600.

According to an embodiment, the recipient terminal 300 may perform authentication to link a connected car account of the recipient to the first vehicle 1. According to an embodiment, the recipient terminal 300 may perform authentication to link the connected car account of the recipient to the second vehicle 2.

For example, when receiving user authentication from the server 600, the recipient terminal 300 may output a user authentication pop-up message, and may transmit authentication completion information to the server 600 when authentication is achieved on the message.

According to an embodiment, the recipient terminal 300 may receive a sharing stop notification with respect to the first vehicle 1 from the server 600. For example, the recipient terminal 300 may receive a sharing stop message with respect to the first vehicle 1 from the server 600.

According to an embodiment, after sharing and account linkage for the second vehicle 2 are performed, the recipient terminal 300 may receive a sharing stop notification with respect to the first vehicle 1 from the server 600.

### First vehicle owner terminal 400

The first vehicle owner terminal 400 is a terminal of an owner (or first vehicle owner) of the first vehicle 1, and may perform account registration and login for the first vehicle owner in association with the server 600.

According to an embodiment, the first vehicle owner terminal 400 may set up vehicle sharing for the recipient in association with the server 600.

According to an embodiment, when the connected car account of the recipient is linked to the second vehicle 2, the first vehicle owner terminal 400 may receive a message indicating that the recipient sharing the first vehicle 1 is linked to the second vehicle 2 from the server 600.

When receiving the message indicating that the recipient is linked to the second vehicle 2, the first vehicle owner terminal 400 may output a sharing stop notification message with respect to the first vehicle 1. For example, the first vehicle owner terminal 400 may provide the message in a pop-up form.

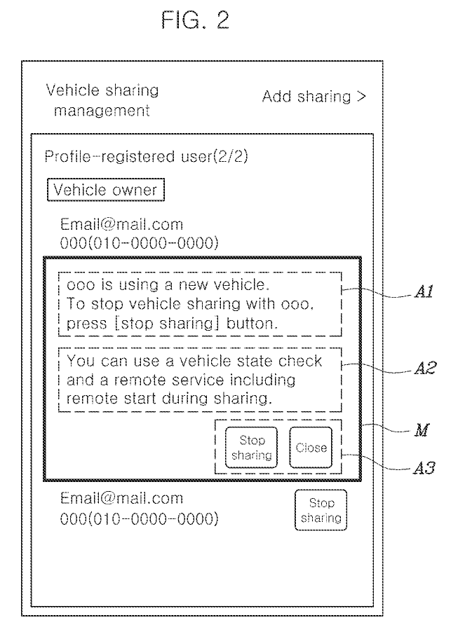

FIG. 2 illustrates an example of a message M provided by the first vehicle owner terminal 400 according to an embodiment of the present disclosure.

As illustrated in FIG. 2, the message M may include a first area A1 in which text indicating that the recipient is shared with another vehicle is displayed, a second area A2 in which text indicating a situation that may occur when the recipient does not stop sharing is displayed, and a third area A3 configured to select whether to stop sharing the first vehicle 1, but the configuration of the message M is not limited thereto.

The first vehicle owner terminal 400 may request the server 600 to stop sharing the first vehicle 1 with the recipient according to a sharing stop instruction from the first vehicle owner.

For example, when a sharing stop button is selected in the third area A3 configured to select whether to stop sharing the first vehicle 1, the first vehicle owner terminal 400 may request the server 600 to stop sharing the first vehicle 1 with the recipient.

### Second vehicle owner terminal 500

The second vehicle owner terminal 500 is a terminal of an owner (or second vehicle owner) of the second vehicle 2, and may perform account registration and login for the second vehicle owner in association with the server 600.

According to an embodiment, the second vehicle owner terminal 500 may set up vehicle sharing for the recipient in association with the server 600.

For example, when the vehicle service provision system according to the embodiment of the present disclosure further includes a third vehicle (not shown) and the connected car account of the recipient with respect to the second vehicle 2 is linked to the third vehicle, the second vehicle owner terminal 500 may receive a message indicating that the recipient sharing the second vehicle 2 is linked to the third vehicle from the server 600.

For example, when receiving the message indicating that the recipient is linked to the third vehicle, the second vehicle owner terminal 500 may output a sharing stop notification message with respect to the second vehicle 2 as shown in FIG. 2.

The second vehicle owner terminal 500 may request the server 600 to stop sharing the second vehicle 2 with the recipient according to a sharing stop instruction from the second vehicle owner.

### Server 600

The server 600 may perform account registration and login for the first vehicle owner by linking with the first vehicle owner terminal 400. In addition, the server 600 may perform account registration and login for the second vehicle owner in association with the second vehicle owner terminal 500.

When a vehicle owner-related user profile (hereinafter, a vehicle owner profile) is selected on the first vehicle terminal 100, the server 600 may provide a connected car service to the first vehicle terminal 100, based on user information corresponding to the selected vehicle owner profile.

When a vehicle owner-related user profile is selected on the second vehicle terminal 200, the server 600 may provide a connected car service to the second vehicle terminal 200, based on user information corresponding to the selected vehicle owner profile.

According to an embodiment, the server 600 may set up vehicle sharing of the first vehicle 1 with the recipient in association with the first vehicle owner terminal 400.

Further, when receiving a request to link the connected car account of the recipient from the first vehicle terminal 100, the server 600 may provide a connected car service to the first vehicle terminal 100, based on the connected car account of the recipient.

According to an embodiment, the server 600 may set up vehicle sharing of the second vehicle 2 with the recipient in association with the second vehicle owner terminal 500.

Further, when receiving a request to link the connected car account of the recipient from the second vehicle terminal 200, the server 600 may provide a connected car service to the second vehicle terminal 200, based on the connected car account of the recipient.

According to an embodiment, when the connected car account requested for linkage from the second vehicle terminal 200 is a connected car account previously linked to the first vehicle 1 (or the first vehicle terminal 100), the server 600 may transmit a message indicating that the recipient sharing the first vehicle 1 is linked to the second vehicle 2 to the first vehicle owner terminal 400.

According to an embodiment, after transmitting the message to the first vehicle owner terminal 400, when receiving a request to stop sharing the first vehicle 1 with the recipient from the first vehicle owner terminal 400 in response thereto, the server 600 may disconnect the account of the recipient, and may transmit information about completion of disconnection of the account of the recipient to the first vehicle terminal 100.

The server 600 may stop vehicle sharing of the first vehicle 1 with the recipient, and may transmit a sharing stop notification message with respect to the first vehicle 1 to the recipient terminal 300.

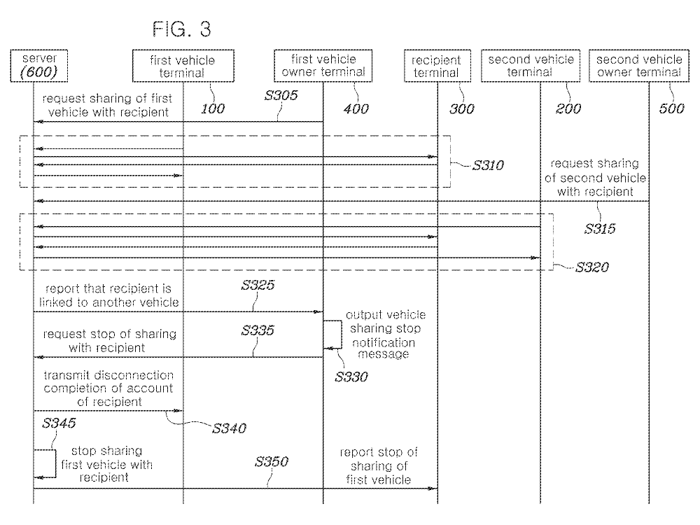

FIG. 3 illustrates a vehicle service provision method according to an embodiment of the present disclosure.

Referring to FIG. 3, a first vehicle owner terminal 400 may be linked to a server 600 according to a maneuver of a first vehicle owner, and may request the server 600 to share a first vehicle 1 with a recipient (operation S305).

In operation S305, the first vehicle owner terminal 400 may provide information about the recipient to the server 600. The information about the recipient may include the phone number, name, ID, and connected car account of the recipient, but is not limited thereto.

The server 600 may register (or store) the fact of vehicle sharing of the first vehicle 1 with the recipient.

When the recipient boards on the first vehicle 1 and selects a user profile of the recipient on the first vehicle terminal 100, the account of the recipient may be linked (operation S310). User authentication may be performed based on the information about the recipient (e.g., the phone number).

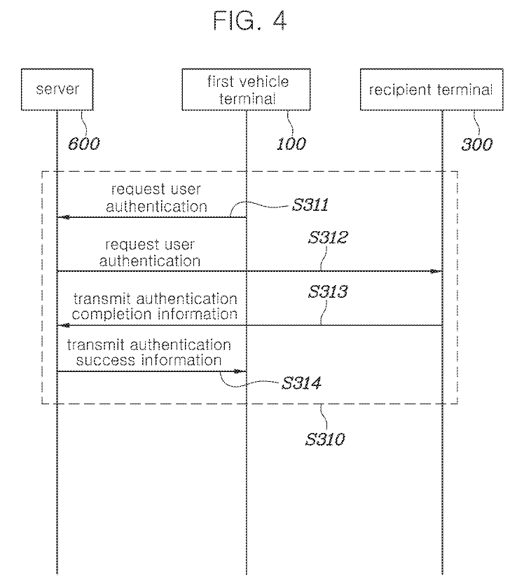

FIG. 4 specifically illustrates linkage of the account of the recipient (operation S310) of FIG. 3.

Referring to FIG. 4, when the recipient selects the user profile of the recipient on the first vehicle terminal 100, the first vehicle terminal 100 may request user authentication from the server 600 (operation S311), and the server 600 receiving a user authentication request may request user authentication from a recipient terminal 300 (operation S312).

The recipient terminal 300 may output a user authentication pop-up message when receiving a user authentication request from the server 600, and may transmit authentication completion information to the server 600 when authentication is performed on the message (operation S313).

When receiving the authentication completion information from the recipient terminal 300, the server 600 may transmit authentication success information to the first vehicle terminal 100 (operation S314).

In this manner, linking the account of the recipient may be achieved by an authentication process performed based on the first vehicle terminal 100, the recipient terminal 300, and the server 600.

Referring back to FIG. 3, when the account of the recipient is successfully linked, the server 600 may provide a connected car service corresponding to the account of the recipient through communication with the first vehicle terminal 100.

Next, a second vehicle owner terminal 500 may be linked to the server 600 according to a maneuver of a second vehicle owner, and may request the server 600 to share a second vehicle 2 with the recipient (operation S315).

In operation S315, the second vehicle owner terminal 500 may provide the information about the recipient to the server 600. The information about the recipient may include the phone number, name, ID, and connected car account of the recipient, but is not limited thereto.

The server 600 may register (or store) the fact of vehicle sharing of the second vehicle 2 with the recipient.

When the recipient boards on the second vehicle 2 and selects the user profile of the recipient on the second vehicle terminal 200, the account of the recipient may be linked (operation S320). User authentication may be performed based on the information about the recipient (e.g., the phone number).

Linking the account of the recipient to the second vehicle 2 may be performed in the same manner as a process of linking the account of the recipient to the first vehicle 1 illustrated in FIG. 3, and a detailed description thereof will be omitted.

The server 600 knows that the recipient is sharing the first vehicle 1 and the account is linked through the first vehicle terminal 100.

Accordingly, after linking the account of the recipient to the second vehicle 2, the server 600 may notify the first vehicle owner terminal 400 that the recipient is linked to another vehicle (the second vehicle) (operation S325).

When receiving a notification that the recipient sharing the first vehicle 1 is linked to the second vehicle 2, the first vehicle owner terminal 400 may output a sharing stop notification message with respect to sharing of the first vehicle 1 with the recipient (operation S330).

In operation S330, the first owner terminal 400 may provide the sharing stop notification message in a pop-up form, and the sharing stop notification message may be configured to select whether to stop sharing of the first vehicle 1.

When a sharing stop button is selected in the sharing stop notification message, the first vehicle owner terminal 400 may request the server 600 to stop sharing of the first vehicle 1 with the recipient (operation S335).

When receiving a sharing stop request from the first vehicle owner terminal 400, the server 600 may disconnect the account of the recipient, and may transmit information about completion of disconnection of the account of the recipient to the first vehicle terminal 100 (operation S340).

The server 600 may stop the vehicle sharing of the first vehicle 1 with the recipient (operation S345), and may transmit a sharing stop notification message with respect to the first vehicle 1 to the recipient terminal 300 (operation S350).

According to an embodiment of the present disclosure, when a connected car account linked from a random vehicle (the second vehicle) is a connected car account previously linked to a different vehicle (the first vehicle), the server 600 may notify a vehicle owner terminal (the first vehicle owner terminal) of the previously linked vehicle (the first vehicle) that the connected car account of a recipient of the vehicle (the first vehicle) is linked to a different vehicle (the second vehicle).

Accordingly, when being notified that the recipient linked to the vehicle (the first vehicle) of the vehicle owner is linked to the different vehicle (the second vehicle) through the terminal (the first vehicle owner terminal) of the vehicle owner, the vehicle owner may request the server 600 to stop sharing of the vehicle (the first vehicle) thereof with the recipient, thereby enabling the server 600 to disconnect the account of the recipient and to stop the sharing with the recipient.

It is assumed in FIG. 3 that the second vehicle owner is different from the recipient and thus the recipient receives sharing of a right to the second vehicle through the connected car account of the recipient, but the same applies when the recipient is the second vehicle owner.

That is, when the connected car account of the recipient with which a right to use a service for the first vehicle is shared is linked to a profile of the second vehicle rather than the first vehicle, the server 600 may notify the owner of the first vehicle that the recipient is linked the profile of the second vehicle.

As described above, in an embodiment of the present disclosure, when a recipient sharing a vehicle links an account through another vehicle, the owner of the vehicle may be notified that the recipient is sharing the other vehicle, enabling the owner of the vehicle to disconnect the account of the recipient and stop vehicle sharing with the recipient.

Accordingly, it is possible to block an inappropriate recipient from accessing the vehicle in advance and prevent the owner of the vehicle from suffering damage due to unintended vehicle sharing.

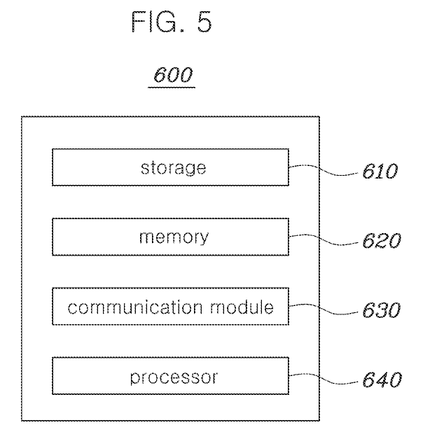

FIG. 5 illustrates an example of the configuration of a server 600 according to an embodiment of the present disclosure.

Referring to FIG. 5, the server 600 may be configured to include a storage 610, a memory 620, a communication module 630, and a processor 640, but the configuration of the server 600 is not limited thereto.

The storage 610 may store information provided from a vehicle managed by the server 600, and may store information provided from a terminal of a user using a connected car service.

The memory 620 may store an algorithm (or program or software), data, and the like for performing an operation of the server 600.

For example, the storage 610 and the memory 620 may be configured as at least one storage medium (or recording medium) among a flash memory, a hard disk, a secure digital (SD) card, a random-access memory (RAM), a static random-access memory (SRAM), a read-only memory (ROM), a programmable read-only memory (PROM), an electrically erasable and programmable ROM (EEPROM), an erasable and programmable ROM (EPROM), a register, a removable disk, and a web storage.

The communication module 630 may include a communication circuit configured to communicate with vehicles 1 and 2 and terminals 400 and 500 through a communication network.

The processor 640 may perform the overall operation of the server 600, and may provide a connected car service by operating based on information stored in the storage 610, an algorithm/data stored in the memory 620, and the like.

The processor 640 may be a data processing device configured as hardware having a circuit with a physical structure for executing desired operations. For example, the desired operations may include a code or instructions included in a program.

For example, the data processing device configured as hardware may include a microprocessor, a central processing unit, a processor core, a multi-core processor, a multiprocessor, an application-specific integrated circuit (ASIC), or a field programmable gate array (FPGA).

In an embodiment of the present disclosure, to perform a function, a first vehicle terminal 100, a second vehicle terminal 200, a recipient terminal 300, a first vehicle owner terminal 400, and a second vehicle owner terminal 500 may include at least one communication module, at least one memory/storage that stores an algorithm (or software or program), data required to perform the algorithm, and information generated or obtained according to an operation, an interface that performs input and output functions for interfacing with a user, and at least one processor.

Although embodiments of the present disclosure have been described above with reference to the accompanying drawings, the present disclosure is not necessarily limited to these embodiments and various modifications and changes may be made thereto without departing from the technical idea of the present disclosure. Therefore, the embodiments set forth herein are not intended to limit the technical idea of the present disclosure but intended to explain the technical idea of the present disclosure, and the scope of the technical idea of the present disclosure is not limited by these embodiments. Accordingly, the embodiments as described above should be construed as being illustrative and non- limitative in all aspects. The scope of protection of the present disclosure should be de fined by the appended claims, and all technical ideas equivalent to the claims shall be construed as falling within the scope of protection of the present disclosure.

What is claimed is:

1. A server configured to provide a connected car service,
wherein a connected car service account of a recipient with which a right to use the connected car service for a first vehicle is shared is linked to a first profile of the first vehicle, and
wherein the server is configured to notify a first vehicle owner terminal corresponding to a terminal of an owner of the first vehicle that the recipient is linked to a second vehicle after the connected car service account of the recipient is linked to a profile of the second vehicle, and stop sharing of a right to use a connected car service for the first vehicle with a connected car service account of the recipient based on a request of the first vehicle owner terminal.

2. The server of claim 1, wherein the second vehicle is a vehicle of the recipient or a vehicle of a third person.

3. The server of claim 2, wherein the second vehicle is the vehicle of the third person, and the server is configured to receive a request to share a right to use a connected car service for the second vehicle from the terminal of the third person.

4. The server of claim 1, wherein the server is configured to notify the first vehicle owner terminal that the recipient is linked to the second vehicle, and stop vehicle sharing of the first vehicle with the recipient based on receiving a request to stop sharing of the first vehicle with the recipient from the first vehicle owner terminal.

5. The server of claim 1, wherein the server is configured to disconnect the account of the recipient from the first vehicle, and transmit account disconnection completion with respect to the recipient to the first vehicle.

6. The server of claim 1, wherein the server is configured to stop vehicle sharing of the first vehicle with the recipient, and transmit a sharing stop notification message with respect to the first vehicle to the terminal of the recipient.

7. A vehicle service provision system comprising:
a first vehicle comprising a first vehicle terminal;
a second vehicle comprising a second vehicle terminal; and
a server linked to the first vehicle and the second vehicle and configured to provide a connected car service to the first vehicle terminal and the second vehicle terminal,
wherein a connected car service account of the recipient with which a right to use the connected car service for a first vehicle is shared is linked to a first profile of the first vehicle, and
wherein the server is configured to notify a first vehicle owner terminal corresponding to a terminal of an owner of the first vehicle that the recipient is linked to a second vehicle after the connected car service account of the recipient is linked to a profile of the second vehicle, and stop sharing of a right to use a connected car service for the first vehicle with a connected car service account of the recipient based on a request of the first vehicle owner terminal.

8. The vehicle service provision system of claim 7, wherein the server is configured to perform vehicle sharing of the first vehicle with the recipient based on a request of the first vehicle owner terminal, and link the account of the recipient based on a request of the first vehicle terminal.

9. The vehicle service provision system of claim 7, wherein the server is configured to perform vehicle sharing of the second vehicle with the recipient based on a request of a second vehicle owner terminal corresponding to a terminal of an owner of the second vehicle, and link the account of the recipient based on a request of the second vehicle terminal.

10. The vehicle service provision system of claim 7, wherein the server is configured to notify the first vehicle owner terminal that the recipient is linked to the second vehicle, and stop vehicle sharing of the first vehicle with the recipient based on receiving a request to stop sharing of the first vehicle with the recipient from the first vehicle owner terminal.

11. The vehicle service provision system of claim 7, wherein the server is configured to disconnect the account of the recipient from the first vehicle, and transmit account disconnection completion with respect to the recipient to the first vehicle.

12. The vehicle service provision system of claim 7, wherein the server is configured to stop vehicle sharing of the first vehicle with the recipient, and transmit a sharing stop notification message with respect to the first vehicle to the terminal of the recipient.

13. The vehicle service provision system of claim 7, wherein the first vehicle owner terminal is configured to output a notification message of stopping sharing of the first vehicle with the recipient after being notified that the recipient is linked to the second vehicle, and request the server to stop sharing of the first vehicle with the recipient after a sharing stop button being selected in the notification message of stopping the sharing.

14. A vehicle service provision method comprising:
sharing, by a server, a right to use a connected car service for a first vehicle with a recipient and linking a connected car service account;
sharing, by the server, a right to use a connected car service for a second vehicle with a recipient and linking the connected car service account;
notifying, by the server, a first vehicle owner terminal corresponding to a terminal of an owner of the first vehicle that the recipient is linked to the second vehicle after the connected car service account of the recipient is linked to the second vehicle; and
stopping, by the server, sharing of the right to use the connected car service for the first vehicle with the connected car service account of the recipient based on a request of the first vehicle owner terminal.

15. The vehicle service provision method of claim 14, wherein, after the notifying, the stopping is performed by the server based on receiving a request to stop sharing of the first vehicle with the recipient from the first vehicle owner terminal.

16. The vehicle service provision method of claim 14, wherein the stopping comprises disconnecting, by the server, the connected car service account of the recipient from the first vehicle, and transmitting account disconnection completion with respect to the recipient to the first vehicle.

17. The vehicle service provision method of claim 14, wherein the stopping comprises stopping vehicle sharing of the first vehicle with the recipient, and transmitting a sharing stop notification message with respect to the first vehicle to the terminal of the recipient.

18. The vehicle service provision method of claim 14, further comprising:
outputting, by the first vehicle owner terminal, a notification message of stopping sharing of the first vehicle with the recipient after being notified that the recipient is linked to the second vehicle; and
requesting, by the first vehicle owner terminal, the server to stop sharing of the first vehicle with the recipient after a sharing stop button being selected in the notification message of stopping the sharing.
